(19) United States
(12) Patent Application Publication
(10) Pub. No.: US 2024/0176183 A1
(43) Pub. Date: May 30, 2024

(54) ILLUMINATION DEVICE AND DISPLAY APPARATUS

(71) Applicant: Sharp Display Technology Corporation, Kameyama City (JP)

(72) Inventors: Hirotoshi YASUNAGA, Kameyama City (JP); Hisashi WATANABE, Kameyama City (JP); Takeshi MASUDA, Kameyama City (JP)

(21) Appl. No.: 18/371,788

(22) Filed: Sep. 22, 2023

(30) Foreign Application Priority Data
Nov. 25, 2022 (JP) 2022-187987

(51) Int. Cl. G02F 1/13357

(52) U.S. Cl. CPC G02F 1/133603; G02F 1/133605

(57) ABSTRACT

An illumination device includes a plurality of light sources, each having a light-emission surface that faces a side opposite to a display panel; a light-source substrate that has a mount surface on a side opposite to the display panel, and that has light transmissivity, the mount surface being provided for mounting the plurality of light sources thereon; and a reflecting layer that is provided on a side of the light-source substrate opposite to the display panel so as to be spaced from the light-emission surfaces by a predetermined interval, and that reflects toward the light-source substrate light coming from the light sources, wherein the illumination device illuminates the display panel with light.

### BACKGROUND

### 1. Field

The technology described in the present specification relates to an illumination device and a display apparatus.

### 2. Description of the Related Art

Hitherto, various technologies that suppress brightness unevenness in a liquid crystal display apparatus have been proposed, and an example thereof is disclosed in Japanese Unexamined Patent Application Publication No. 2005-321693. The liquid crystal display apparatus described in Japanese Unexamined Patent Application Publication No. 2005-321693 includes a light-emitting part, a liquid crystal display element, and a diffusion plate that is disposed therebetween. The light-emitting part includes a light-guiding body and one or more light-emitting elements that are embedded in the light-guiding body, the light guiding body having a light-reflecting surface, which is a scattering reflecting surface, and a light-transmitting surface. The average of an angle formed between the light-reflecting surface and the light-transmitting surface is from 7 degrees to 23 degrees. Such a structure is regarded as being capable of making uniform a light intensity distribution without increasing the light quantity of the one or more light-emitting elements.

However, when an illumination device is made very thin, even if the structure described in Japanese Unexamined Patent Application Publication No. 2005-321693 above is used, it may be difficult to make uniform a light intensity distribution, and brightness unevenness caused by the arrangement of light sources may occur.

The technology described in the specification of the present application has been completed based on such circumstances above, and it is desirable to suppress brightness unevenness while decreasing thickness.

### SUMMARY

(1) According to an aspect of the present technology, there is provided an illumination device including a plurality of light sources, each having a light-emission surface that faces a side opposite to a display panel; a light-source substrate that has a mount surface on a side opposite to the display panel, and that has light transmissivity, the mount surface being provided for mounting the plurality of light sources thereon; and a reflecting layer that is provided on a side of the light-source substrate opposite to the display panel so as to be spaced from the light-emission surfaces by a predetermined interval, and that reflects toward the light-source substrate light coming from the light sources, in which the illumination device illuminates the display panel with light.

(2) According to another aspect of the present technology, there is provided a display apparatus including the illumination device according to (1) above.

### BRIEF DESCRIPTION OF THE DRAWINGS

FIG. 1 is a sectional view of a liquid crystal display apparatus according to a first embodiment;

FIG. 2 is a plan view of an LED substrate on which LEDs are mounted;

FIG. 3 is a partial sectional view showing in enlarged form the vicinity of LEDs in FIG. 1;

FIG. 4 is a partial sectional view showing in enlarged form the vicinity of LEDs of a backlight device according to a second embodiment;

FIG. 5 is a partial sectional view showing in enlarged form the vicinity of LEDs of a backlight device according to another embodiment; and

FIG. 6 is a partial sectional view showing in enlarged form the vicinity of LEDs of a backlight device according to another embodiment.

### DESCRIPTION OF THE EMBODIMENTS

### First Embodiment

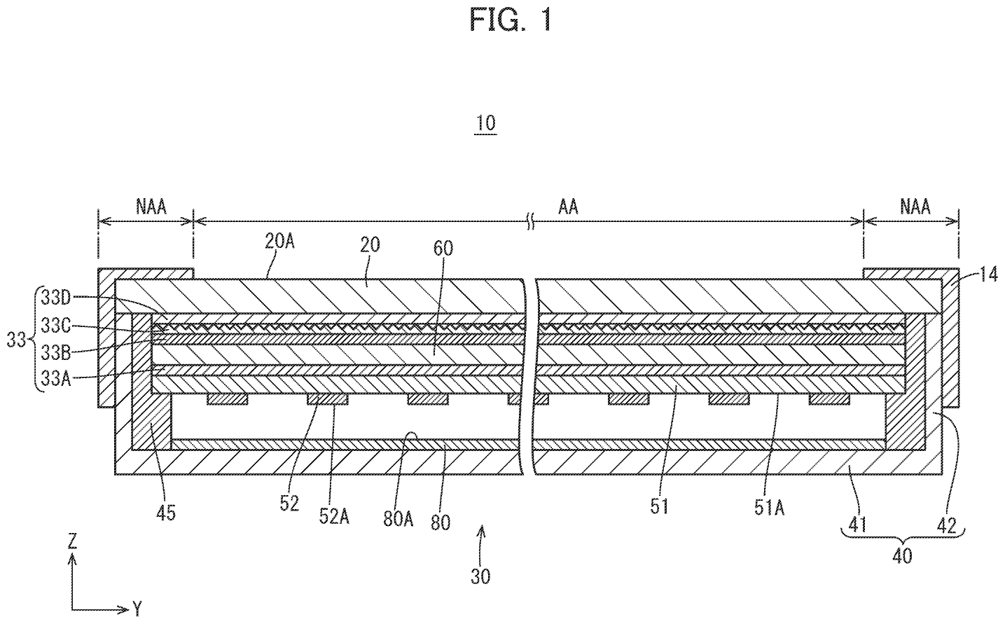

A first embodiment is described with reference to FIGS. 1 to 3. In the present embodiment, a liquid crystal display apparatus (an example of a display apparatus) 10 including a backlight device 30 (an example of an illumination device) is exemplified. Note that each figure shows an X axis, a Y axis, and a Z axis, and each axial direction is indicated to become a common direction in each figure. In the Z-axis direction, a liquid-crystal-panel-20 side is a front side, and a backlight-device-30 side is a rear side.

As shown in FIG. 1, the liquid crystal display apparatus 10 includes a liquid crystal panel (an example of a display panel) 20 that displays an image, a backlight device (an example of an illumination device) 30 that illuminates the liquid crystal panel 20 with light, and a bezel 14 (front bezel). The liquid crystal panel 20 with its display surface 20A that is capable of displaying an image facing the front side is interposed between the bezel 14 and a chassis 40 (rear bezel) of the backlight device 30 described below. An in-plane of the liquid crystal panel 20 is divided into a display region AA that displays an image and a non-display region NAA that has a frame shape to surround the display region AA and that does not display an image. The liquid crystal panel 20, the backlight device 30, and the liquid crystal display apparatus 10 in the present embodiment each have as a whole a rectangular shape that is long sideways, with a long side direction coinciding with the X-axis direction in each figure, a short side direction coinciding with the Y-axis direction in each figure, and a thickness direction coinciding with the Z-axis direction in each figure. However, the illustrated shape is an example and thus their shapes are not limited thereto.

As shown in FIG. 1, the bezel 14 is a supporting member that is disposed on the front side of the liquid crystal panel 20. The bezel 14 extends along a front-side peripheral edge portion of the liquid crystal panel 20 and constitutes a front-side exterior of the liquid crystal display apparatus 10. The bezel 14 is made of, for example, a metal (such as stainless steel or aluminum) having excellent rigidity.

As shown in FIG. 1, the backlight device 30 includes a plurality of LEDs 52 (examples of light sources), an LED substrate 51 (an example of a light-source substrate) on which the LEDs 52 are mounted, a wavelength conversion sheet 60 (an example of a color conversion sheet or a wavelength conversion member), a plurality of types of optical sheets 33, a reflecting layer 80, the chassis 40, and a frame 45. The LEDs 52 are arranged in a planar manner on the rear side (lower side) of the liquid crystal panel 20, and the backlight device 30 is a so-called direct-type backlight device.

As shown in FIG. 1, the chassis 40 has the shape of a tray that opens toward a light-exiting side (liquid-crystal-panel-20 side), and the reflecting layer 80 is set on a bottom portion 41 thereof. The chassis 40 is made of, for example, a metal (such as stainless steel or aluminum). An outer peripheral edge portion of the chassis 40 constitutes a side wall 42 protruding toward the front. The frame 45 has the shape of a frame, is provided on an inner side of the side wall 42 of the chassis 40, and is adjacent to the side wall 42. The frame 45 is made of, for example, a resin, such as white polycarbonate having excellent light reflectivity. A step is formed at an inner surface of the frame 45, and the LED substrate 51 on which the LEDs 52 are mounted, the wavelength conversion sheet 60, and the various types of optical sheets 33 are set by being placed upon each other on the step. However, these members may be supported by a member that differs from the frame 45.

The bezel 14, the frame 45, and the chassis 40 integrally hold the liquid crystal panel 20 and the backlight device 30. A tape-like member may be affixed to the bezel 14, the frame 45, and the like as appropriate for fixation and light-shielding. The bezel 14 and the frame 45 may have a shape that is not the shape of a frame.

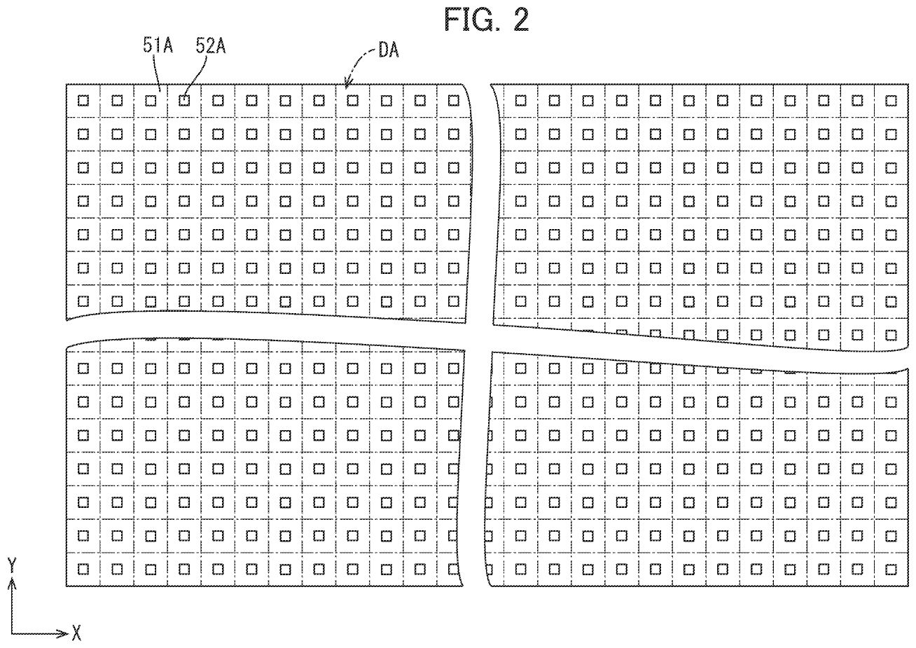

As shown in FIGS. 1 and 2, the LEDs 52 are arranged in a lattice (matrix) at substantially equal intervals in the X-axis direction (row direction) and the Y-axis direction (column direction) on a rear-side main surface (mount surface 51A) of the LED substrate 51 having a rectangular shape. Each LED 52 has a parallelepiped shape, and is of a so-called top light-emission type (top view type) in which its bottom surface is disposed on the mount surface 51A and its upper surface opposite to the bottom surface becomes a light-emission surface 52A. Each light-emission surface 52A faces a side opposite to the liquid crystal panel 20, and faces the reflecting layer 80. An optical axis (direction of propagation of light whose light-emission intensity of emission light is the highest (becomes a peak)) of each LED 52 corresponds to the Z-axis direction.

Each LED 52 is a small LED whose light-emission surface 52A has an area that is 5.0 mm² or smaller and is thus a small LED that is smaller than a general LED (whose light-emission surface has an area that is about 10.0 mm²). Each LED 52 may be a so-called mini-LED or a micro-LED whose light-emission surface 52A has an area that is 0.01 mm² or larger and 1.0 mm² or smaller. Each LED 52 according to the present embodiment is of a monochromatic light-emission type, and, for the purpose of decreasing the size of each LED 52, does not include a fluorescent body. Each LED 52 emits, for example, blue light (primary light) included in a wavelength region of about 420 nm to about 500 nm. Each LED 52 has a structure in which a monochromatic light-emitting element is sealed by a sealing material made of a transparent resin material not including a fluorescent body. Note that each LED 52 may be of a white-light light-emission type including a fluorescent body; or a small package, such as a CSP (Chip Scale Package) or a flip-chip-type package, may be used for each LED 52.

The LED substrate 51 has a structure in which a wire pattern made of an electrically conductive material is formed on a light-transmissive base plate (for example, a glass base plate). As shown in FIG. 1, the mount surface 51A of the LED substrate 51 is provided to face the side opposite to the liquid crystal panel 20, that is, to face a bottom-portion-41 side of the chassis 40. That is, the rear-side main surface of the LED substrate 51 becomes the mount surface 51A. A transparent protective layer may be formed on the mount surface 51A. The protective layer is, for example, a PET (polyethylene terephthalate) resin layer adhered to the mount surface 51A with OCA or a silicon mold. For example, the protective layer may form part of the mount surface 51A by potting with a transparent resin material.

As shown in FIG. 2, the mount surface 51A is divided into a plurality of division regions (segment regions) DA that are disposed side by side in rows and columns without gaps therebetween. In the present embodiment, each division region DA has a rectangular shape, and includes one LED 52 at its central portion. Each division region DA may have a size for including at least one LED 52, and the pitch between the division regions DA and the number of LEDs 52 included in each division region DA can be changed as appropriate in accordance with the screen size, the use, and a demanded precision of the liquid crystal panel 20.

Drive electric power is supplied to each LED 52 from an external power source through the wire pattern formed on the LED substrate 51. In the backlight device 30, the wire pattern and the like are constituted such that local dimming driving in which the drive electric power that is supplied to each LED 52 is independently controlled for each division region DA is performed. Therefore, the light-emission quantity of each LED 52 can be locally adjusted for each division region DA. The backlight device 30 and the liquid crystal display apparatus 10 are capable of, by the local dimming driving, performing high-resolution and high-contrast brightness adjustments and reducing power consumption.

The wavelength conversion sheet 60 converts emission light (primary light) of each LED 52 into light (secondary light) having a longer wavelength. More specifically, the wavelength conversion sheet 60 passes therethrough part of blue light coming from each LED 52 and absorbs the other part of the blue light to emit yellow light. The backlight device 30, by using the monochromatic light-emission type LEDs 52 in combination with the wavelength conversion sheet 60, emits white synthetic light (mixed light). However, when each LED 52 is of a white light emission type, the wavelength conversion sheet 60 may not be provided.

The wavelength conversion sheet 60 includes a wavelength conversion layer and a base material that is provided on one or both of two main surfaces of the wavelength conversion layer. The wavelength conversion layer includes a fluorescent body. The fluorescent body is not limited in type as long as the fluorescent body is capable of converting primary light into secondary light included in a wavelength region differing from that of the primary light, and is, for example, a quantum dot fluorescent body, an inorganic fluorescent body, or an organic fluorescent body. The base material is a portion that supports the wavelength conversion layer, and is made of, for example, a resin (such as a polyether-based resin or an acrylic resin) having high transparency. For the base material, a dichroic sheet (described below) may be used, or a base material in which a dichroic sheet and a transparent resin sheet are bonded together with a transparent adhesive (such as an OCA (Optical Clear Adhesive)) may be used.

The optical sheets 33, by being interposed between the LED substrate 51 and the liquid crystal panel 20, impart a predetermined optical action to light coming from each LED 52. Various types of optical sheets 33 are known, and one type or a plurality of types of optical sheets 33 are used as appropriate in accordance with, for example, uses of the liquid crystal display apparatus 10. In the present embodiment, as an optical sheet 33, as shown in FIG. 1, a dichroic sheet (dichroic filter) 33A is disposed between the LED substrate 51 and the wavelength conversion sheet 60. In addition, a light diffusion sheet 33B and two brightness enhancement sheets 33C and 33D are disposed between the wavelength conversion sheet 60 and the liquid crystal panel 20.

The dichroic sheet 33A is an optical sheet having a bandpass filter function, and, by being combined with the wavelength conversion sheet 60, is capable of enhancing color reproducibility. The dichroic sheet 33A of the present embodiment has a filter function of passing therethrough blue light coming from each LED 52 and of reflecting yellow light (mixed light of green light and red light) coming from the wavelength conversion sheet 60.

The light diffusion sheet 33B, by imparting a diffusion action to light coming from the wavelength conversion sheet 60, increases in-plane uniformity. The thickness of the light diffusion sheet 33B is in the range of, for example, about 30 μm to about 3 mm. The brightness enhancement sheets 33C and 33D, by imparting a light condensation action to emission light coming from the light diffusion sheet 33B, enhance frontal brightness.

As the brightness enhancement sheets 33C and 33D, for example, a BEF (Brightness Enhancement Film) (registered trademark) series of 3M company can be used. The two brightness enhancement sheets 33C and 33D are disposed such that the directions of extension of unit lenses (for example, mountain-shaped cross-section unit lenses) thereof are orthogonal to each other. Other specific examples of the optical sheets 33 include brightness enhancement sheets of, for example, a DBEF (Dual Brightness Enhancement Film) (registered trademark) series, turning lenses, diffusion sheets, and prism sheets (prism or lens-shaped optical sheets, excluding brightness enhancement sheets and turning lenses).

As shown in FIG. 1, the reflecting layer 80 is provided on a rear side of the LED substrate 51 so as to be spaced from the light-emission surface 52A of each LED 52 by a predetermined interval. The reflecting layer 80 reflects toward the LED substrate 51 light coming from each LED 52. The reflecting layer 80 according to the present embodiment is a sheet-shaped member (reflecting sheet) whose main surface facing the LED substrate 51 is flat. At least a front-side main surface 80A of the reflecting layer 80 has excellent reflectivity. The reflecting layer 80 is formed from, for example, a polyester-based or a PET-based white resin sheet, such as an ESR (Enhanced Specular Reflector), or a layer in which a base material is coated with a white coating. This makes it possible to realize high reflectivity as a result of light being diffusively reflected (reflected in a scattered manner) by the main surface 80A. The reflecting layer 80 is, for example, a metal sheet, such as a silver (Ag) sheet or an aluminum (Al) sheet, or a layer in which a metal material, such as silver (Ag) or aluminum (Al), is evaporated onto a base material. This makes it possible to realize high reflectivity as a result of light being specularly reflected by the main surface 80A.

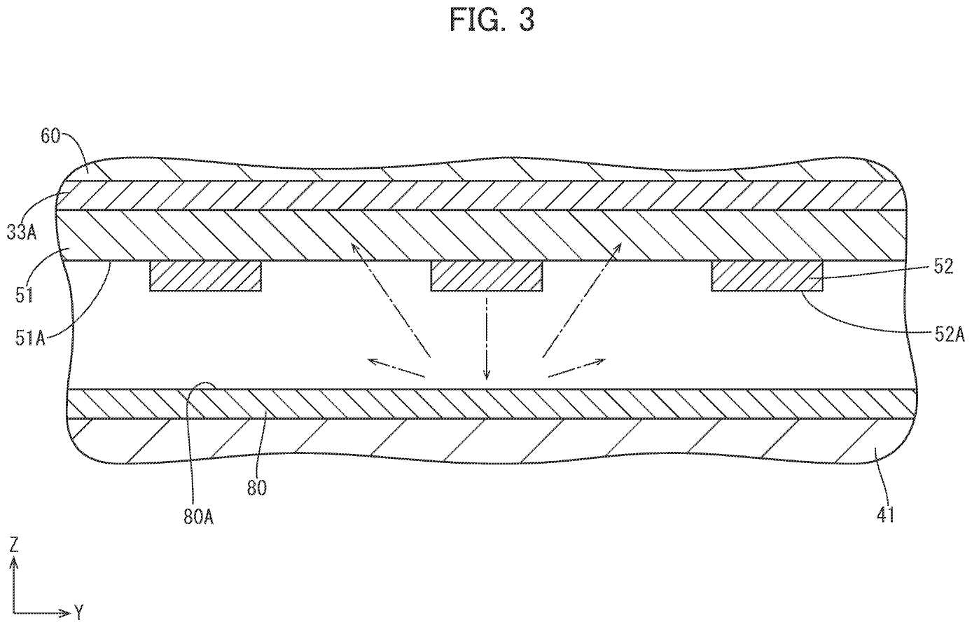

Next, the operations and effects of the above-described backlight device 30 are described. Light emitted toward the rear side from the light-emission surface 52A of each LED 52 is, as shown in FIG. 3, reflected toward the LED substrate 51 by the front-side main surface 80A of the reflecting layer 80. The LED substrate 51 has light transmissivity, and light incident upon the LED substrate 51 by the reflection passes through the inside of the LED substrate 51 and exits toward the front side. Therefore, the light coming from each LED 52, after propagating from each light-emission surface 52A to the reflecting layer 80 that is situated opposite to each light-emission surface 52A, is reflected to the LED substrate 51 from the reflecting layer 80, as a result of which the light travels back and forth between the LED substrate 51 and the reflecting layer 80. Therefore, even if the backlight device 30 is made thin (the dimension in the Z-axis direction is decreased), a distance in the thickness direction (the Z-axis direction) of an amount allowing light emitted from each LED 52 to be diffused is easily ensured.

Each light-emission surface 52A faces the side opposite to the liquid crystal panel 20 and is capable of suppressing brightness unevenness and color unevenness (so-called hot spot or LED unevenness) in which the brightness in the vicinity of the LEDs 52 (region that is superimposed upon the LEDs 52) is excessively high and in which the vicinity has the color of the primary light (in the embodiment, blue). As a result, the brightness unevenness and the color unevenness can be suppressed while decreasing the thickness.

If LEDs of ordinary sizes are used for the LEDs 52, the light reflected toward the LED substrate 51 from the above-described reflecting layer 80 tends to be blocked by the LEDs. Therefore, small LEDs (so-called mini-LEDs or micro-LEDs) are used for the LEDs 52 to make it possible to increase the light transmissivity of the LED substrate 51 with respect to reflected light from the reflecting layer 80 and to suppress a reduction in the use efficiency of light.

### Second Embodiment

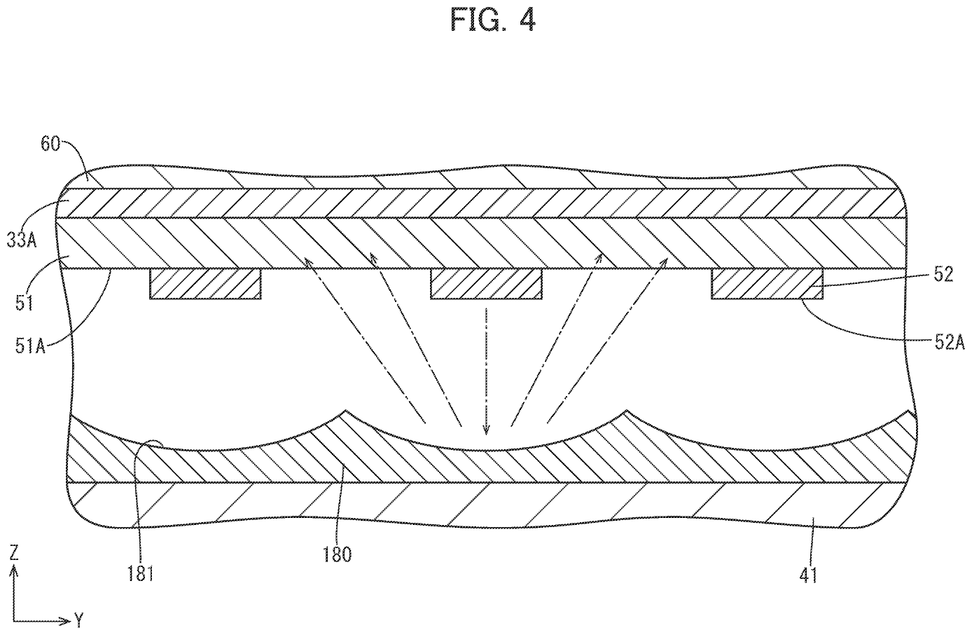

A reflecting layer 180 according to a second embodiment is described with reference to FIG. 4. Structures, operations, and effects of the second embodiment that are the same as those of the first embodiment are not described.

The reflecting layer 180 includes a hollow portion 181 whose surface has a curved shape. The hollow portion 181 is provided at a position on a front-side surface of the reflecting layer 180, the position being where the hollow portion 181 faces a light-emission surface 52A of each LED 52. This makes it possible to condense reflected light from the reflecting layer 180 toward the front side by the hollow portion 181. As a result, it is possible to decrease light propagating toward an outer peripheral edge portion that is superimposed upon a non-display region NAA and to increase the use efficiency of light.

It is possible to, when part of the plurality of LEDs 52 are driven (turned on) by local dimming driving, suppress propagation of light coming from a dimming region (driving dimming region) including LEDs 52 that are turned on to a dimming region (non-driving dimming region) in the vicinity where LEDs 52 are not driven. Therefore, it is possible to suppress a decrease in the brightness of the backlight device 30 and a decrease in contrast in the brightness of the backlight device 30 when the backlight device 30 is partly turned on, both of which occur when the non-driving dimming region is slightly bright.

The hollow portion 181 is integrally formed with the reflecting layer 180 by using a resin material, and is made of, for example, a white resin material. Therefore, it is possible to realize high reflectivity by diffusively reflecting (reflecting in a scattered manner) light.

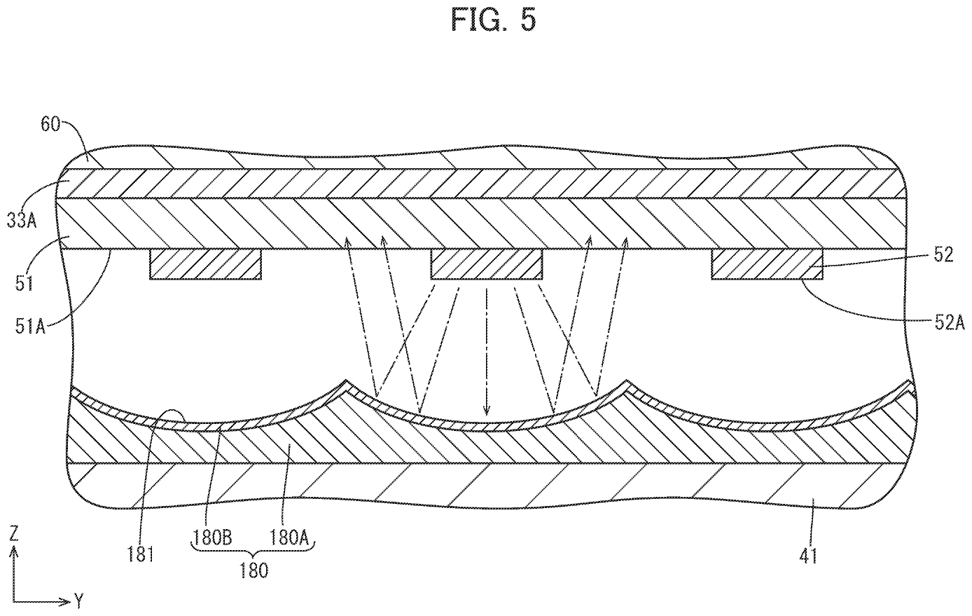

As in another embodiment shown in FIG. 5, the reflecting layer 180 may be a reflecting layer in which a metal layer 180B, such as a silver (Ag) layer or an aluminum (Al) layer, is evaporated onto a base material 180A made of a resin material. This makes it possible to realize high reflectivity as a result of light being specularly reflected by a surface of the metal layer 180B.

### Another Embodiment

The present disclosure is not limited to the embodiments described by the descriptions and drawings above, and, for example, an embodiment such as the following is also included within the technical scope of the present disclosure.

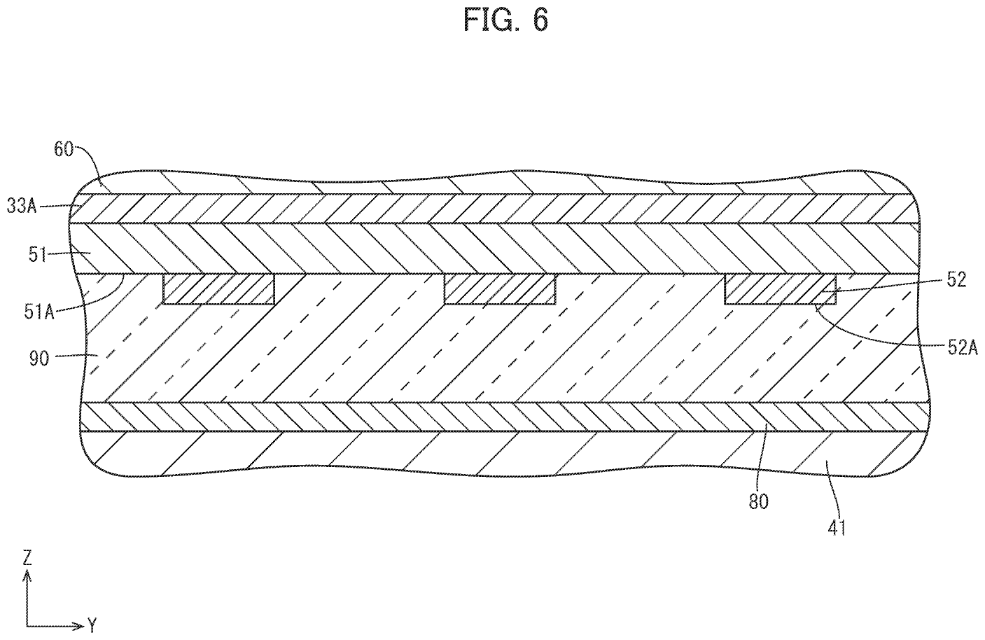

(1) As in an example shown in FIG. 6, a space between the LED substrate 51 and the reflecting layer 80 or the reflecting layer 180 may be filled with a transparent resin material 90.

The present disclosure contains subject matter related to that disclosed in Japanese Priority Patent Application JP 2022-187987 filed in the Japan Patent Office on Nov. 25, 2022, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An illumination device comprising:
a plurality of light sources, each having a light-emission surface that faces a side opposite to a display panel;
a light-source substrate that has a mount surface on a side opposite to the display panel, and that has light transmissivity, the mount surface being provided for mounting the plurality of light sources thereon; and
a reflecting layer that is provided on a side of the light-source substrate opposite to the display panel so as to be spaced from the light-emission surfaces by a predetermined interval, and that reflects toward the light-source substrate light coming from the light sources,
wherein the illumination device illuminates the display panel with light.

2. The illumination device according to claim 1,
wherein each of the light sources is an LED whose light-emission surface has an area that is 0.01 mm² or larger and 1.0 mm² or smaller.

3. The illumination device according to claim 1,
wherein each of the light sources is of a monochromatic light-emission type, and
wherein the illumination device further comprises
a wavelength conversion member for converting a wavelength of the light coming from the light sources, the wavelength conversion member being provided on a side of the light-source substrate where the display panel is provided.

4. The illumination device according to claim 1,
wherein the reflecting layer has a hollow portion whose surface has a curved shape, the hollow portion being provided at a position on a surface of the reflecting layer, the surface being provided on a side of the light-source substrate, the position being where the hollow portion faces the light-emission surfaces.

5. The illumination device according to claim 1,
wherein the reflecting layer is a sheet-shaped member whose surface on a side of the light-source substrate is flat.

6. The illumination device according to claim 1,
wherein a surface of the reflecting layer on a side of the light-source substrate diffusively reflects light.

7. The illumination device according to claim 6,
wherein the surface of the reflecting layer on the side of the light-source substrate is made of a white resin material.

8. The illumination device according to claim 1,
wherein a surface of the reflecting layer on a side of the light-source substrate specularly reflects light.

9. The illumination device according to claim 8,
wherein the surface of the reflecting layer on the side of the light-source substrate is made of a metal material.

10. The illumination device according to claim 1,
wherein a space between the light-source substrate and the reflecting layer is filled with a transparent resin material.

11. The illumination device according to claim 1,
wherein the mount surface is divided into a plurality of division regions, each of the division regions having a size for including at least one of the light sources, and
wherein the plurality of light sources are independently drivable for each of the division regions.

12. A display apparatus comprising:
the illumination device according to claim 1.

13. The display apparatus according to claim 12,
wherein the display panel is a liquid crystal panel.
